(19) United States
(12) Patent Application Publication
(10) Pub. No.: US 2017/0174816 A1
(43) Pub. Date: Jun. 22, 2017

(54) FLEXIBLE, OPEN-CELL THERMOSET FOAMS AND BLOWING AGENTS AND METHODS FOR MAKING SAME

(71) Applicant: HONEYWELL INTERNATIONAL INC., Morris Plains, NJ (US)

(72) Inventor: Ronald S. Grossman, Buffalo, NY (US)

(21) Appl. No.: 15/409,416

(22) Filed: Jan. 18, 2017

Related U.S. Application Data
(63) Continuation-in-part of application No. 14/701,511, filed on Apr. 30, 2015.
(60) Provisional application No. 62/279,990, filed on Jan. 18, 2016.

(51) Int. Cl. C08G 18/08; C08G 18/76; C08G 18/48; C08J 9/14

(52) U.S. Cl. CPC C08G 18/14; C08J 9/144; C08G 18/7671; C08G 18/4812; C08J 2203/182; C08J 2205/05; C08J 2375/08; C08G 2101/005

(57) ABSTRACT

Disclosed are methods and compositions for forming a flexible, open cell molded foams based on MDI-based isocyanate comprising at least one polymer polyol present in the composition in an amount of at least about 6 pphp; one or more components capable of forming a thermoset matrix; and a blowing agent comprising at least one chemical blowing agent, such as water, and at least one physical blowing agent selected from the group consisting of trans-1-chloro-3,3,3-trifluoropropene (HFC0-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), and combinations of any two or more of these.

### CROSS REFERENCE TO RELATE APPLICATIONS

This application is a continuation-in-part of and claims the priority benefit of, and incorporates herein by reference, U.S. application Ser. No. 14/701,511 filed Apr. 30, 2015.

This application also claims the priority benefit of US Provisional Application 62/279,990, filed Jan. 18, 2016, which is incorporated herein by reference.

### FIELD OF THE INVENTION

The present invention relates to improved open-cell flexible thermoset foams and to compositions and methods for forming such foams.

### BACKGROUND OF THE INVENTION

One of the most common thermoset flexible foams are polyurethane foams. Such foams are typically prepared by reacting a polyisocyanate, with an active hydrogen-containing compound, such as a. polyol, in the presence of a blowing agent and other optional ingredients,

Catalysts are employed to promote two major reactions to produce the foam. One reaction is primarily a chain extending isocyanate-hydroxyl reaction or gelation reaction by which a hydroxyl-containing molecule is reacted with an isocyanate-containing molecule to form a urethane linkage. The progress of this reaction increases the viscosity of the mixture, and generally contributes to crosslink formation with polyfunctional polyols (i.e. polyols having a. nominal functionality above 2). The second major reaction comprises an isocyanate-water reaction which forms carbon dioxide as a reaction product. The CO2 thus generated serves to “blow” or assist in the “blowing” of the foam. The in-situ generation of carbon dioxide by this reaction plays an essential part in the preparation of many flexible polyurethane foams, including open-cell flexible foams. Heretofore such foams have frequently been referred to as “water-blown” flexible polyurethane foams.

While the use of water as the primary source of blowing agent in such foams is typical and frequently adequate, problems and/or deficiencies can be associated with such water-blown flexible foams. For example, in order to reduce the density of such foams, which in many applications is a highly desirable result, it is generally known that it might be possible to achieve a. decrease in foam density by increasing the amount of the blowing agent. For water-blown foams, increasing the amount of water in the foamable mixture is a common approach to decrease foam density since additional water in the foaming composition will generally result in more CO2, and hence increase the amount of blowing agent. However, the isocyanate-water reaction that produces the carbon dioxide blowing agent (i.e. the water reaction is exothermic. As a result, the use of additional water to generate additional CO2 blowing agent has the consequence of increasing the heat that is generated in the foaming reaction. In many cases, this additional heat can cause serious problems for the foaming process and/or the foam product produced. These potential disadvantages can be understood with reference to the types of intended applications for the flexible foam and the types of processes used to form the foam. As a result, limitations have been observed on the ability to increase water levels generally to about 3.8%; above this level problems have been known to arise, including the fact that the foam tends to become boardy and has a sandpaper feel leading to poor compression set

Flexible, open-cell polyurethane foams have applications in a variety of products and, depending on the end use, can be tailor made to fit the particular application and desired physical properties. The polyurethane industry has come to recognize two, generally distinct, categories of flexible foam products: high resilience foams and conventional, lower resilience foams. High resilience (HR) foam is widely used for furniture cushions, mattresses, automotive cushions and padding, and numerous other applications requiring foams have properties similar to those describe above. Conventional foam also is used in these applications and finds additional applications in the areas of carpet underlays and packaging materials.

One particular type of HR foam is flexible, viscoelastic polyurethane foam (also known as “dead” foam, “slow recovery” foam, or “high damping” foam). This type of foam is characterized by slow, gradual recovery from compression. While most of the physical properties of viscoelastic foams resemble those of conventional foams, the resilience of viscoelastic foams is much lower, generally less than about 15%. Suitable applications for viscoelastic foam take advantage of its shape conforming, energy attenuating, and sound damping characteristics. For example, the foam can be used in mattresses to reduce pressure points, in athletic padding or helmets as a shock absorber, and in automotive interiors for soundproofing.

Various synthetic approaches have been used to make viscoelastic foam. Formulators have modified the amount and type of polyol(s), polyisocyanate, surfactants, foaming catalysts, fillers (see, e.g., U.S. Pat. No. 4,367,259, which is incorporated herein by reference), or other components, to arrive at foams having low resilience, good softness, and the right processing characteristics. Too often, however, the window for processing these formulations is undesirably narrow. Other viscoelastic foam formulations and processing techniques are disclosed in U.S. Pat. No. 6,391,935, U.S. Pat. No. 6,586,485, U.S. Pat. No. 6,734,220 and US 200510210595, each of which is incorporated herein by reference.

Commercially, water-blown flexible polyurethane foams are produced by both molded and free-rise (slab foam) processes. Conventional foam is most frequently made using the free-rise process. FIR foam often is made using closed molds. Slab foams are generally produced more or less continuously by the free-rise process in large buns which, after curing, are sliced or otherwise formed into useful shapes. For example, carpet underlayment is sliced from large buns of polyurethane foam. Molding is typically utilized to produce, in what is essentially a batchwise process, an article in essentially its final dimensions. Automotive seating and sonic furniture cushions are examples of employment of the molding process. Slab foam buns produced using the free-rise process tend to be much larger than molded foams. While molded foam objects are normally less than about ten cubic feet in volume, slab foam buns are rarely less than 50 cubic feet in volume.

Each process has its advantages and disadvantages, and the impact of increasing water content to effect a decrease in density may be different in each. However, it is generally considered unacceptable if a decrease in density is associated with a substantial increase in rigidity. This is because while lower densities are generally desirable, if the means used to achieve this result produce an increase in the rigidity of the final foam, the foam will be considered not acceptable or at least of a lower quality; lower value. This is because rigidity is contrary to the intended purpose of such foams for the primary use as seat cushions, mattresses, sofa cushions, carpet underlayment and the like.

In general, the use of water to improve (i.e., lower) the density of open cell, flexible foam is not a viable option beyond a certain point because it tends to cause other problems with the foam, such as an unacceptable increase in rigidity. Furthermore, by using additional water to blow a foam with decreased density can cause foam over-heating and significantly increases the hazard of fire, especially in slab foams because of the large volume of foam being produced. The hazard of fire is diminished when producing molded foam due to the small volume of the articles produced which facilitates their rapid cooling. In both cases, however, use of increased water can result in other problems, such as foam splitting, i.e. sizeable openings or voids in either or both the surface and, interior of the foam.

It has been suggested that other, inert blowing agents may be used in addition to water in the formation of flexible foams. See for example U.S. Pat. No. 7,268,170. The '170 patent discloses that such other blowing agents can include halogenated hydrocarbons, liquid carbon dioxide, low boiling solvents such as, for example, pentane, and other known blowing agents. However, there is no indication that a careful selection from among this large group of possible blowing agents can be used in conjunction with water to achieve a reduction in foam density while maintaining one or more of the other important foam properties, such as IFD 25%, IFD 65%, tensile strength and elongation, compression set, and preferably all of these, at acceptable levels. Applicants have found that a careful selection of certain halogenated hydrocarbons for use in combination with water as a blowing agent is capable of achieving this and/or other advantageous, highly desirable and unexpected results, as explained hereinafter.

### SUMMARY OF THE INVENTION

The present invention relates to novel open-cell flexible thermoset foams, preferably molded foam, and to composition and methods for forming such foams and to articles formed from such foams. The invention involves the use of foamable compositions which comprise water blowing agent and certain organic, inert co.-blowing agents, including certain RFC, UFO and/or HFC0 compounds, to form foamable compositions that have several unexpected advantages in terms of processing of the foam and the resultant foam properties. As used in the context of blowing agent, the term “inert” means that the blowing agent acts principally, and preferably essentially entirely, as a physical blowing agent (as opposed to a chemical blowing agent).

In certain highly preferred embodiments, the present invention provides a method of forming a flexible, open cell foam comprising: (a) providing a foamable, thermosetting composition capable of forming an open-cell, flexible foam, said composition comprising (i) one or more components capable of forming a thermoset matrix, preferably a polyurethane matrix; and (ii) a blowing agent for forming open cells in said matrix, said blowing agent comprising, preferably comprising at least 75% by weight of, more preferably comprising at least about 85%, in certain embodiments consisting essentially of, and in certain embodiments consisting of, a combination of water and a co-blowing agent selected from the group consisting of 1 1,1,4,4,4-hexafluoro-2-butene (1.336inzz) (cis, trans or any combination of these); trans-1-chloro-3,3,3-trifluoropropene (HFC0-1233zd(E)), 1,1,1,3,3-pentafluoropropane (HFC-245fa); 1,1,1,3,3-pentafluorobutane (365mfc), and blends consisting essentially of at least about 80% of HFC-365mfc and 1,1,1,2,3,3,3-heptafluoropropane (227ea) and combinations of any two or more of these; and (b) forming from said foamable composition a flexible foam comprising a matrix comprising thermoset polymer and a plurality of open cells in said matrix.

In certain preferred embodiments, the relative amounts of said water to said co-blowing agent(s) is effective such that said methods: (1) produce a foam having a substantial density reduction in free-rise density compared to the same method but in which the co-blowing agent is not present; and/or (2) said providing step, especially and preferably in methods of forming molded flexible foam, utilizes a substantially reduced amount of foamable composition compared to the same method but in which the co-blowing agent is not present. In highly preferred embodiments, the substantial density reduction and/or foamable composition reduction is achieved while providing one or more of the following properties, and preferably at least any two of the following properties, and more preferably any three of the following properties, in a substantially acceptable value:

(a) IFD 25%

(b) IFD 65%

(c) comfort factor

(d) compression set

(e) resilience

(f) hysteresis loss.

As used herein the term “substantial density reduction” means a reduction in density of at least 5% relative to the density of the same foam produced without the co-blowing agent.

As used herein the term “substantially reduced amount of foamable composition” means at least about 5% less foamable composition relative to the amount of foamable composition needed to form the article in the absence of said co-blowing agent.

As used herein the term “substantially increase in hysteresis loss” means an increase in hysteresis loss that is at least about a 5 relative percent increase in hysteresis loss.

It is contemplated that the present invention can be used to advantage in many types and varieties of flexible, open-cell foam. It is generally preferred, however, that the foams according to the present invention have a density of less than about 8 pounds per cubic foot (hereinafter “PCF”), more preferably less than about 7 PCF, and in certain preferred embodiments of less than about 6PCF. For embodiments involving viscoelastic foam, the density of the foam is preferably less than about 7 pounds per cubic foot, more preferably less than about 6 PCF, and in certain preferred embodiments is in the range of from about 3 PCF to about 7 PCF, more preferably in certain embodiments in the range of from about 4PCF to about 6 PFC.

In certain embodiments, including particularly HR foam, the density of the foam is not greater than about 4.5 PCF (including particularly for MDI-based foam, and even more particularly molded MDI-based foam), more preferably not greater than about 3 PCF and in certain embodiments even more preferably not greater than 2.5 PCF (including particularly for MDI-based foam, and even more particularly molded MDI-based foam). The difficulty of achieving such density reductions according to prior art methods is believed to result, at least in part, from the large size of the hard segment polymer domains in MDI, relative to those in TDI, and also because of the lower NCO of MDI on a per pound basis.

In certain preferred embodiments, the present methods achieve a free-rise density reduction that is reduced at least about 5 relative percent, more preferably in certain embodiments at least about 8 relative percent, more preferably in certain embodiments at least about 10 relative percent, and even more preferably in certain embodiments at least about 12 relative percent. In certain highly preferred embodiments, including in each of the preferred embodiments described in the preceding sentence, the free-rise density reduction is achieved in an amount of up to about 15 relative percent. As used herein, the term “free-rise density reduction” means the density of foam made according the present methods and/or compositions as measured in free-rise, in comparison to the density of the free-rise foam produced using the same method but without said co-blowing agent.

As used herein, the term “hysteresis loss” refers to a measure of the energy loss between loading and unloading the foam, which is quantified by measuring the area under the curve from loading or indenting the foam, minus the area under the curve from removing the load or indenting device from the foam pursuant to the procedures outlined in ASTM D3574 Appendix X6. When the test is run on a full foam block, this is referred to herein as IFD Hysteresis, and when the test is fun on a cube of foam cut from the molded part or from the block, this is referred to herein as CFD Hysteresis.

In preferred embodiments, and especially those embodiments relating to viscoelastic foam, the preferred density reductions are achieved while also achieving viscoelastic foam having low resilience, i.e., less than 15% as measured in the standard ball rebound test (ASTM D 3574-95, Test H), more preferably in certain embodiments the foams have resilence less than 10%; and even more preferably in certain embodiments the foams have a resilience of less than 5%. In addition, the preferred viscoelastic foams have a high degree of softness, as indicated by 25% IFD (indentation force deflection at 25% compression, ASTM D 3574, Test B1—values that are preferably less than about 22 lbs. (about 100 Newtons (N)). Preferred foams also have low compression sets. For example, preferred foams exhibit a 90% compression set value, (Ct (ASTM D 3574, Test D—70 C and ambient humidity), of less than about 15%, more preferably less than about 10% and even more preferably less than about 5%.

In certain preferred embodiments, and especially those embodiments relating to viscoelastic foam, each of the preferred reductions in density is achieved without decreasing the 90% compression set value, Ct (ASTM D 3574, Test D), by more than about 20 relative percent, more preferably not more than about 10 relative percent. In certain preferred embodiments, each of the preferred reductions in density is achieved without increasing the resilience as measured in the standard ball rebound test (ASTM D 3574-95, Test H) by more than about 20 relative percent, more preferably not more than about 10 relative percent.

In preferred embodiments, each of the preferred reductions in density is achieved without decreasing elongation as measured by ASTM D3574 Test E by more than about 25 relative percent.

In preferred embodiments, each of the preferred reductions in density is achieved without decreasing elongation as measured by ASTM D3574 Test E by more than about 20 relative percent.

In preferred embodiments, each of the preferred reductions in density is achieved without decreasing elongation as measured by ASTM D3574 Test E by more than about 10 relative percent.

In preferred embodiments, each of the preferred reductions in density is achieved without degrading comfort factor by more than about 20 relative percent.

In preferred embodiments, each of the preferred reductions in density is achieved without degrading comfort factor by more than about 10 relative percent.

In preferred embodiments each of the preferred reductions in density is achieved without changing Indent Force Deflection (IFD) at 25% as measured by ASTM D3574 Test B1 by more than 25 relative percent.

In preferred embodiments each of the preferred reductions in density is achieved without changing Indent Force Deflection (IFD) at 25% as measured by ASTM D3574 Test B1 by more than 20 relative percent.

In preferred embodiments each of the preferred reductions in density is achieved without changing Indent Force Deflection (IFD) at 25% as measured by ASTM D3574 Test B1 by more than 10 relative percent.

In certain preferred embodiments, especially for viscoelastic foam each of the preferred reductions in density is achieved while achieving in the foam a comfort factor (“CF” also sometimes referred to as “comfort value (CV)) of from about 1.25 to 2.8 for High Resilience HR foam.

In preferred embodiments, the CV is from about 2 to about 4 and the density is reduced according to each of the preferred density reduction amounts specified above.

In preferred embodiments, the CV is from about 2 to about 3 and the density is reduced according to each of the preferred density reduction amounts specified above.

In preferred embodiments, the CV is from about 2.2 to about 2.8 and the density is reduced according to each of the preferred density reduction amounts specified above.

As used herein, the terms comfort factor and CF mean the ratio of IFD at 65% to the IFD at 25%. The CF is an important property indicator in certain applications, such as for example in automobile seat cushion manufacture, in that it is considered to represent the preferred balance of a foam that is soft but at the same time supportive.

In certain preferred embodiments each of the preferred reductions in density is achieved while achieving a foam with a 50% compression set at 70° C. and ambient relative humidity (unless otherwise indicated herein, this is sometimes referred to simply as Compression Set), also known as “constant deflection compression set) as measured by ASTM D3574 Test D, of not greater than 15%.

In preferred embodiments each of the preferred reductions in density is achieved while achieving a foam with a 50% compression set at 70° C. and ambient relative humidity (unless otherwise indicated herein, this is sometimes referred to simply as Compression Set), also known as “constant deflection compression set) as measured by ASTM D3574 Test D, of not greater than 12%.

In preferred embodiments each of the preferred reductions in density is achieved while achieving a foam that does not exhibit more than a 25 relative percent increase in CFD hysteresis loss.

In preferred embodiments each of the preferred reductions in density is achieved while achieving a foam that does not exhibit more than a 20 relative percent increase in CFD hysteresis loss.

In preferred embodiments each of the preferred reductions in density is achieved while achieving a foam that does not exhibit more than a 10 relative percent increase in CFD hysteresis loss.

In preferred embodiments each of the preferred reductions in density is achieved while achieving a foam that does not exhibit an increase in CFD hysteresis loss.

In preferred embodiments each of the preferred reductions in density is achieved while achieving a foam that does not exhibit a substantial increase in CFD hysteresis loss.

In preferred embodiments each of the preferred reductions in density is achieved while achieving a foam with a 50% compression set at 50° C. and 95% relative humidity as measured by ASTM D3574 Test D, of not greater than 10%.

In preferred embodiments each of the preferred reductions in density is achieved while achieving a foam with a 50% compression set at 50° C. and 95% relative humidity as measured by ASTM D3574 Test D, of not greater than 12%.

In certain highly preferred embodiments, each of the preferred reductions in density is achieved while simultaneously achieving the preferred values as mentioned herein of at least two, more preferably at least three, and in certain preferred embodiments preferably all of the following foam properties: IFD at 25%; IFD at 65%; elongation; compression set; comfort factor; and hysteresis loss, most preferably CFD hysteresis loss.

In highly preferred embodiments in which the foam is slab foam, each of the preferred reductions in density is achieved while simultaneously achieving a reduction of the exotherm associated with the process of producing the foam.

In highly preferred embodiments in which the foam is slab foam, each of the preferred reductions in density is achieved while simultaneously achieving a reduction of the exotherm associated with the process of producing the foam by at least about 10.

In highly preferred embodiments in which the foam is slab foam, each of the preferred reductions in density is achieved while simultaneously achieving a reduction of the exotherm associated with the process of producing the foam in an amount of from about 10 to about 20 relative percent.

In highly preferred embodiments in which the foam is TDI-based slab foam, each of the preferred reductions in density is achieved while simultaneously achieving a reduction of the exotherm associated with the process of producing the foam.

In highly preferred embodiments in which the foam is TDI-based slab foam, each of the preferred reductions in density is achieved while simultaneously achieving a reduction of the exotherm associated with the process of producing the foam by at least about 10.

In highly preferred embodiments in which the foam is TDI-based slab foam, each of the preferred reductions in density is achieved while simultaneously achieving a reduction of the exotherm associated with the process of producing the foam in an amount of from about 10 to about 20 relative percent.

In highly preferred embodiments in which the foam is TDI/MDI-based slab foam, each of the preferred reductions in density is achieved while simultaneously achieving a reduction of the exotherm associated with the process of producing the foam.

In highly preferred embodiments in which the foam is TDI/MDI-based slab foam, each of the preferred reductions in density is achieved while simultaneously achieving a reduction of the exotherm associated with the process of producing the foam by at least about 10.

In highly preferred embodiments in which the foam is TDI/MDI-based slab foam, each of the preferred reductions in density is achieved while simultaneously achieving a reduction of the exotherm associated with the process of producing the foam in an amount of from about 10 to about 20 relative percent.

In highly preferred embodiments, particularly those involving slab foam and even more preferably TDI-based or TDI/MDI based slab foam, each of the preferred reductions in density is achieved while simultaneously achieving a reduction of the exotherm associated with the process of producing the foam, preferably in certain embodiments by at least about 10, and preferably from about 10 to about 20 relative percent.

The present invention also provides in certain embodiments foamable compositions comprising one or more components capable of forming a thermoset matrix, preferably a polyurethane matrix; and (b) a blowing agent for forming open cells in said matrix, said blowing agent comprising, and in certain embodiments consisting essentially of, water and a co-blowing agent selected from the group consisting of I 1,1,4,4,4-hexafluoro-2-butene (I.336ruzz) (cis trans or any combination of these); trans-.1-chloro-3,3,3-trifluoropropene (HFC0-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), and combinations of any two or more of these.

The present invention also provides in certain embodiments a blowing agent composition for use in forming a flexible, open-cell thermoset foam, preferably a polyurethane foam, said blowing agent composition comprising, and in certain embodiments consisting essentially of, water and a co-blowing agent selected from the group consisting of 1 1,1,4,4,4-hexafluoro-2-butene (1336mzz) (cis, trans or any combination of these); trans-1-chloro-3,3,3-trifluoropropene (HFCO-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), and combinations of any two or more of these.

The present invention also provides in certain embodiments foamable compositions comprising (a) one or more components capable of forming a polyurethane matrix; and (b) a blowing agent for forming open cells in said matrix, said blowing agent comprising, and preferably consisting essentially of, water and a co-blowing agent selected from the group consisting of 1,1,1,4,4,4-hexafluoro-2-butene (1336ruzz) (cis, trans or any combination of these); trans-1-chloro-3,3,3-trifluoropropene (HFC0-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), and combinations of any two or more of these.

The present invention also provides in certain embodiments foamable compositions comprising (a) one or more components capable of forming a polyurethane matrix; and (b) a blowing agent for forming open cells in said matrix, said blowing agent comprising, and preferably consisting essentially of, water and a co-blowing agent consisting essentially of 1,1,1,4,4,4-hexafluoro-2-butene (1336ruzz) (cis, trans or any combination of these).

The present invention also provides in certain embodiments foamable compositions comprising (a) one or more components capable of forming a polyurethane matrix; and (b) a blowing agent for forming open cells in said matrix, said blowing agent comprising, and preferably consisting essentially of, water and a co-blowing agent consisting essentially of trans-1-chloro-3,3,3-trifluoropropene (HFC0-1233zd(E)).

The present invention also provides in certain embodiments foamable compositions comprising (a) one or more components capable of forming a polyurethane matrix; and (b) a blowing agent for forming open cells in said matrix, said blowing agent comprising, and preferably consisting essentially of, water and a co-blowing agent consisting essentially of 1,1,1,3,3-pentafluoropropane (HFC-245fa).

The present invention also provides in certain embodiments foamable compositions comprising (a) one or more components capable of forming a polyurethane matrix; and (b) a blowing agent for forming open cells in said matrix, said blowing agent comprising, and preferably consisting essentially of, water and a co-blowing agent consisting essentially of 1,1,1,3,3-pentafluorobutane (365mfc).

The present invention also provides in certain embodiments foamable compositions comprising (a) one or more components capable of forming a polyurethane matrix; and (b) a blowing agent for forming open cells in said matrix, said blowing agent comprising, and preferably consisting essentially of, water and a co-blowing agent consisting essentially of blends of at least about 80% of HFC-365mfc and 1,1,1,2,3,3,3-heptafluoropropane (227ea).

One advantage that can be achieved in accordance with the present invention is the ability to form a low density, open—cell polyurethane foam having desirable physical properties, and in certain embodiments one or more properties (including the properties identified above) that are approximately as good as or better than foams made according to prior methods and compositions, and at the same time achieving a substantial advantage in raw material usage (e.g., polyurethane), preferably at least about 5%, more preferably at least about 10%, and in certain embodiments about 12%, compared to prior methods and compositions.

Certain preferred embodiments of the present invention provide a molded MDI-based foam formed from a foamable composition comprising:

A) one or more polyisocyanates, preferably comprising in major proportion, and in certain embodiments comprising at least about 80% by weight of MDI-type polyisocyanates, based on the total weight of the total isocyantes;

B) one or more isocyanate-reactive hydrogen containing compounds including at least one polymer polyol, wherein said polymer polyol is present in the formulation in an amount of greater than 6 pphp, more preferably from about 8 pphp to about 30 pphp, even more preferably from about 8 pphp to about 20 pphp, preferably 8 pphp to about 15 pphp in certain embodiments, with amounts of about 10 pphp or greater being preferred in some embodiment;

(C) blowing agent, wherein the blowing agent comprises water and one or more co-blowing agents comprising one or more of 1 1,1,4,4,4-hexafluoro-2-butene (1,336mzz (cis, trans or any combination of these); trans-1-chloro-3,3,-trifluoropropene (HFC.0-1233zd(E)), 1,1,1,3,3-pentafluoropropane (HFC-245fa); 1,1 . . . -pentafluorobutane (365mfe), blends consisting essentially of at least about 80% of HFC-365mfe and 1,1₂1,2,3,3,3-heptalluoropropane (227ea, wherein the amount of the co-blowing agents} is at least in preferred embodiments about 50% by weight of blowing agent composition

D) catalyst;

E) optionally but preferably surfactant;

F) optionally but preferably foam modifier; and

G) optionally other additives.

Certain preferred embodiments of the present invention provide a molded NIDI-based foam formed from a foamable composition comprising:

A) one or more polyisocyanates, preferably, comprising in major proportion, and in certain embodiments comprising at least about 80% by weight of MDI-type polyisocyanates;

B) one or more isocyanate-reactive hydrogen containing compounds including at least one polymer polyol comprising from 35% to 50% by weight, more preferably from about 40 to about 50% by weight, of, AN polymer grafted thereto, wherein said polymer polyol is present the formulation in an amount of greater than 6 pphp, more preferably from about 8 pphp to about 20 pphp, even more preferably from about 8 pphp to about 15 pphp in certain embodiments, with amounts of about 10 pphp or greater being preferred in some embodiment;

C) blowing agent, wherein the blowing agent comprises water and one or more co-blowing agents comprising one or more of trans-1-chloro-3,3,3-trifluoropropene (HFCO-1233zd(E)), 1,1,1,3,3-pentafluoropropane (HFC-245fa.); 1,1,13,3-pentafluorobutane (365mfc), blends consisting essentially of at least about 80% of HFO-365mfc and 1,1,1,2,3,3,3-heptafluoropropane (227ea), wherein the amount of the co-blowing agent(s) is at least in preferred embodiments about 50% by weight of blowing agent composition;

D) catalyst;

E) optionally but preferably surfactant;

F) optionally but preferably foam modifier; and

G) optionally other additives.

Certain preferred embodiments of the present invention provide a molded MDI-based foam formed from a foamable composition comprising:

A) one or more polyisocyanates, preferably, comprising in major proportion, and in certain embodiments comprising at least about 80% by weight of MDI-type polyisocyanates;

B) one or more isocyanate-reactive hydrogen containing compounds including at least one polymer polyol comprising from 35% to 50% by weight, more preferably from about 40 to about 50% by weight, of SAN polymer grafted thereto, wherein said polymer polyol is present in the formulation, in an amount of greater than 6 pphp, more preferably from about 8 pphp to about 20 pphp, even more preferably from about 8 pphp to about 15 pphp in certain embodiments, with amounts of about 10 pphp or greater being preferred in some embodiment;

C) blowing agent, wherein the blowing agent comprises water and one or more co-blowing agents comprising trans-1-chloro-3,3,3-trifluoropropene 4;1-(HFCO-1233zd(E), wherein the amount of the 1-HFCO-1.233zd(E) in the blowing agent(s) is at least in preferred embodiments about 50% by weight of blowing agent composition;

D) catalyst;

E) optionally but preferably surfactant;

F) optionally but preferably foam modifier; and

G) optionally other additives.

Certain preferred embodiments of the present invention provide a molded MDI-based foam formed from a foamable composition comprising:

A.) one or more polyisocyanates, preferably comprising in major proportion, and in certain embodiments comprising at least about 80% by weight of MDI-type polyisocyanates;

B) one or more isocyanate-reactive hydrogen containing compounds including at least one polymer polyol comprising from 35% to 50% by weight, more preferably from about 40 to about 50% by weight, of SAN polymer grafted thereto, wherein said polymer polyol is present in the formulation in an amount of greater than 6 pphp, more preferably from about 8 pphp to about 20 pphp, even more preferably from about 8 pphp to about 15 pphp in certain embodiments, with amounts of about 10 pphp or greater being preferred in some embodiment;

C) blowing agent, wherein the blowing agent comprises water and one or more co-blowing agents comprising 1,1,1,3,3-pentafuoropropane (HFC-245fa.), wherein the amount of the HFC-245fa in the blowing agent(s) is at least in preferred embodiments about 50% by weight of blowing agent composition;

D) catalyst;

E) optionally but preferably surfactant;

F) optionally but preferably foam modifier; and

G) optionally other additives.

Certain preferred embodiments of the present invention provide a molded MDT-based foam formed from a foamable composition comprising:

A. one or more polyisocvanates, preferably comprising in major proportion, and in certain embodiments comprising at least about 80% by weight of DvIDI-type polyisocyanates;

B) one or more isocyanate-reactive hydrogen, containing compounds including at least one polymer polyol comprising from 35% to 50%) by weight, more preferably from about 40 to about 50% by weight, of SAN polymer grafted thereto, wherein said polymer polyol is present in the formulation in an amount of greater than 6 pphp, more preferably from about 8 pphp to about 20 pphp, even more preferably from about 8 pphp to about 15 pphp in certain embodiments, with amounts of about 10 pphp or greater being preferred in sonic embodiment;

C) blowing agent, wherein the blowing agent comprises water and one or more co-blowing agents comprising a blend consisting essentially of at least about 80% of HFC-365mfc and 1,1,1,2,3,3,3-heptafluoropropane (227ea), wherein the amount of the blend in the blowing agent(s) is at least in preferred embodiments about 50% by weight of blowing agent composition;

D) catalyst;

E) optionally hut preferably surfactant,

F) optionally but preferably foam modifier; and

G) optionally other additives.

Certain preferred embodiments of the present invention provide a, molded MDT-based foam formed from a (tamable composition comprising:

A) one or more polyisocyanates, preferably comprising in major proportion, and in certain embodiments comprising at least about 80% by weight of MDI-type polyisocyanates;

B) one or more isocyanate-reactive hydrogen containing compounds including at least one polymer polyol comprising from 35% to 50% by weight, more preferably from about 40 to about 50% by weight, of SAN polymer grafted thereto, wherein said polymer polyol is present in the formulation in an amount of greater than 6 pphp, more preferably from about 8 pphp to about 20 pphp, even more preferably from about 8 pphp to about 15 pphp in certain embodiments, with amounts of about 10 pphp or greater being preferred in some embodiment;

C) blowing agent, wherein the blowing agent comprises water and one or more co-blowing agents comprising 1,1,1,4,4,4-hexafluoro-2-butene (1336mzz) cis, trans or any combination of these), wherein the amount of the 1336mzz in the blowing agents) is at least in preferred embodiments about 50% by weight of blowing agent composition;

D) catalyst;

E) optionally but preferably surfactant;

F) optionally but preferably foam modifier; and

(G) optionally other additives.

### DETAILED DESCRIPTION OF PREFERRED EMBODIMENTS

In general, the present invention is adaptable for use in connection with either the slabstock method and to foarnable compositions for use with the slabstock method, but it is preferred that the embodiments of the invention comprise the molding method of terming flexible polyurethane foams, and even more preferably in certain embodiments to cold cure molding of flexible, open cell foam and to foamable compositions for use with the molding method. Preferably, the foams of the present invention are polyurethane foams. As used herein, the terms “polyurethane foam” generally refers to cellular products as obtained by reacting polyisocyanates with one or more isocyanate-reactive hydrogen containing compounds, in the presence of a blowing agent, and in particular includes cellular products obtained with water as reactive or chemical ⁻blowing agent (involving a reaction of water with isocyanate groups yielding urea linkages and carbon dioxide). The term. “polyurethane foamable compositions” refers to compositions capable of being formed into a polyurethane foam.

As used herein, the term “flexible polyurethane foam” refers to cellular products which have a, substantial proportion of open cells, and even more preferably consists essentially of open cells, and which exhibit substantial shape recovery after deformation,

The preferred polyurethane foams comprise the reaction product of an aromatic polyisocyanate component and an isocyanate-reactive component, preferably comprising one or more hydroxyl functional materials, including preferably polyoxyalkylene polyether polyols. In general, the reaction mixture preferably includes one or more catalysts, one or more surfactants and a ⁻blowing agent component.

As used herein the term “pphp” means park by weight per hundred parts by weight of the total polyol components in the formulation.

Foamable Compositions For both slabstock and molded methods, the preferred foamable compositions and foams are polyurethane-based and will generally include the following components:

A) one or more polyisocyanates;

B) one or more isocyanate-reactive hydrogen containing compounds;

C) blowing agent

D) catalyst;

E) surfactant;

F) foam modifier;

G) other additives.

In general, it is contemplated that those skilled in the art will be able to select and adjust the type and amount of each of these components in view of the teachings contained herein to achieve advantageous foam, foamable compositions and methods of the present invention, and all such selections and adjustments are within broad scope of the present invention. According to preferred aspects of the invention, the materials and amounts described below have certain advantages.

A. Isocyanates

Those skilled in the art will appreciate that the type and amount of isocyanate can vary widely depending on many factors, including, whether the foamable composition is to be used in slabstock methods or molding methods, and the particular requirements of the methods involved and the expected end-use for the foam being formed.

Although many types of isocyanates are adapatable for use, in general, it is contemplated that the preferred compositions will comprise one or more aromatic polyisocyanate components, including preferably components based on MDI (diphenylmethane diisocyanate) c, TDI (toluene diisocyanate), mixtures of polymeric MDI and TDI, and modified versions of these, and combinations of these.

The terms “polymethylene polyphenylene polyisocyanates” and “MDI” are used herein to refer to polyisocyanates selected from diphenylmethane diisocyanate isomers, polyphenyl polymethylerie polyisocyanates and derivatives thereof bearing at least two isocyanate groups and containing carbodiimide groups, uretonimine groups, isocyanurate groups, urethane groups, allophanate groups, urea groups or biuret groups. They arc, obtainable, for example, by condensing aniline with formaldehyde, followed by phosgenation, which process yields what is called crude MDI, by fractionation of said crude MDT, which process yields pure MDI and polymeric MDI, and by autocondensation, of crude, pure or polymeric MD1, or reaction of excess of crude, pure or polymeric MIN with polyols or polyamines, which processes yield modified MDI, containing carbodiimide, uretonimine, isocyanurate, urethane, allophanate, urea or biuret groups. Examples of MDI that are adaptable for use in accordance with the present invention are provided in U.S. Pat. No. 5,399,594, which is incorporated herein by reference.

It is contemplated that in certain embodiments the isocyanate can include, 2,4′-diphenylmethane diisocyanate (2,4′-MDI, 4,4′-diphenylmethane diisocyanate (4,4′-MDI), H12MDI (hydrogenated. MD1).

The term “TDI” is used, herein to toluene dissocyanates general, and is intended to include but is not limited to 2,4-toluene diisocyanate (2,4-TDI), 2,6-tolylene diisocyanate (2,6-TDI), H6TDI (hydrogenated TDI), and combinations of these.

It is also contemplated that the isocyanate in general, and the MDI and the TDI components in particular, can include materials known as urethane prepolymers obtained by the pre-reaction/reacting such isocyanate compounds with one or more of the polyol compounds, including those described below.

Other isocyantes can be used instead of or in addition to one or more of the MDI components or TDI components, including 1,4-phenylene diisocyanate, xylylene diisocyanate (XDI), tetramethylxylylene diisocyanate (TMXDI), tolidine diisocyanate (TODI), and 1,5-naphthalene diisocyanate. (NDI); aliphatic polyisocyanates such as hexamthylenc, diisocyanate (HDI), trimethylhexamethylene diisocyanate (TMHDI), lysine diisocyanate, and norbornane diisocyanate methyl (NBDI); alicyclic polyisocyanates such as transcyclohexane-1,4-diisocyanate, isophorone diisocyanate (IPDI), H6XDI (hydrogenated XDI),

Once again, the type and the amount of the various isocyante components to be included can be determined by those skilled in the art in view of the teaching contained herein.

It is also contemplated that the amount of the isocyanate, relative to the other components of the foamable composition according to the present invention can vary widely within the scope hereof, and all such relative amounts are within the broad scope of the invention. In general, however, it preferred that the amount of isocyanate is selected relative to the amount of the one or more isocyanate-reactive hydrogen, containing compounds so as to obtain an Index of from about 75 to about 115, more preferably from about 80 to about 110 and even more preferably from about 85 to 105. The term “index” is used by those skilled in the art as a shortcut term to indicate the ratio of NCO (isocyanate) groups to OH, water and other isocyanate-reactive groups in the foam. For instance, an Index of 85 indicates a, ratio of 0.85, while an index of 105 indicates a ratio of 1.05.

In preferred embodiments, the isocyanate has an NCO percentage that can vary widely within the scope hereof. In certain preferred embodiments, the NCO of the isocyanate in the foamable composition is from about 20 to about 32%, more preferably from about 25 to about 32, and the NCO in the foam is from 12 to about 29%.

B. Isocyanate-Reactive Hydrogen Containing Compounds

As used herein, the term “isocyanate:—reactive hydrogen containing compounds” or “isocyanate-reactive compounds” includes polyols as well as polyamines and combinations of these. The term “polyurethane foam” is thus intended also to include products which comprise urethane linkages together with urea linkages and even products which essentially comprise urea linkages with few or no urethane linkages. The isocyanate-reactive hydrogen containing compounds preferably comprising one or more hydroxyl functional materials, including preferably polyoxyalkylene polyether polyols.

Once again, it is contemplated that the type and amount of isocyanate-reactive hydrogen containing compounds, including the polyol, can, be readily selected for use with the present invention in view of the teachings contained herein. In certain preferred embodiments, polyol is used and is preferably selected from polyether polyol, a polyester polyol, or a, polyol chain extender.

In highly preferred embodiments the isocyanate-reactive hydrogen containing compounds comprise, more preferably comprise in major proportion, polyether polyol(s). Representative examples of polyether polyols are polyether diols such as polypropylene glycol, polyethylene glycol and polytetramethylene glycol; polyether triols such as glycerol triols; polyether tetrols and pentols such as aliphatic amine tetrols and aromatic amine tetrols; polyether octols such as sucrose octol; and others such as sorbitol, trimethylol propane, and pentaerythritol. Of course, any combination of any two or more of these may be used and combined or not with other isocyanate-reactive hydrogen containing compounds.

In preferred embodiments the isocyanate-reactive component comprises a polyol, and even more preferably a blend of polyols. In certain preferred embodiments, the polyol, comprises polyether polyol (such as may be formed by reacting polypropylene oxide and glycerol), and even more preferably in certain embodiments a polyether polyol having a molecular weight (MW) of from about 2,000 to about 10,000 preferably 3000 to 8000 and most preferably 4500 to 7500. With respect to functionality, it is preferred that the poly component has a functionality of from about 1 to about 6, more preferably from about 2 to about 5, and even more preferably from about 2 to about 4.

In preferred embodiments of the present invention the polyol component of the present invention comprises a combination of at least two polyols wherein a substantial portion of the polyol is a polymer polyol. As the term is used herein, “polymer polyol” refers to a stable dispersion of a solid polymer phase within the liquid polyol, polyol blend or polyol containing blend, wherein the solid polymer is preferably formed by in situ polymerization of low molecular weight compounds within the liquid phase, in preferred embodiments the polymer phase comprises, and in certain embodiments consists essentially of SAN polymer, preferably where the S AN polymer comprised from about 40 to about 75% by weight of the polymer polyoll, preferably from about 40 to about 55% by weight. One such polymer is described in US 2009/0281206, which is incorporated herein by reference.

Preferred SAN Polymer Polyols which are Commercially Available Include by Way of Preferred Examples:

| SAN Polymer Polyol | Properties |
|---|---|
| Plura.col ® 1365 | Nominal functionality, 2 |
| from BASF | OH No. (Avg) = 69 |
| | % Solids (wt % SAN) = 50 |
| | Viscosity (cps @ 25 C.) = 3800 |
| | EO Cap-No |
| Pluracol ® 1528 FF | Nominal functionality = 3 |
| from BASF | OH No. (Avg) = 19 |
| | % Solids (wt % SAN = 43 |
| | Viscosity cps @ 25 C.) = 5500 |
| | EO Cap-Yes |
| Pluracol ® 5132 | Nominal functionality = 3 |
| from BASF | OH No. (Avg) - 25 |
| | % Solids (wt % SAN) = 32 |
| | Viscosity (cps @ 25 C.) = 3300 |
| | EO Cap-Yes |
| Pluracol ® 4600 | Nominal functionality, 3 |
| from BASF | OH No Avg) = 31 |
| | % Solids (wt. % SAN) = 45 |
| | Viscosity (cps @ 25 C.) = 4200 |
| | EO Cap-No |
| Pluracol ® 5250 | Nominal functionality = 3 |
| from BASF | OH No. (Avg) = 28 |
| | % Solids (wt %) SAN) = 50 |
| | Viscosity (cps @ 25 C.) = 5700 |
| | EO Cap-No |
| Arcot ® HS-100 | OH No. (Avg) = 262-30.2 |
| from Bayer | % Solids (wt % SAN) = approx 45 or greater |
| | Viscosity (cps @ 25 C.) = 3100 |
| Hyperlite ® @ E-852 | OH No. (Avg) = 18.2-22.2 |
| from Bayer | % Solids (wt % SAN), approx, 45 or greater |
| | Viscosity (cps @ 25 C.) = 3100 |
| Hypt.Tlite ® E-852 | OH No. (Avg) - 18.2 22.2 |
| from Bayer | % Solids (wt % SAN), approx. 45 or greater |
| Hyperlite ® E-850 | OH No. (Avg) = 18.2-22.2 |
| from Bayer | % Solids wt % SAN) = approx. 45 or greater |
| | MW = 88,600 |

In certain preferred embodiments, the amount of the isocyanate-reactive hydrogen containing compounds, and in preferred embodiments the polyol components, comprise from about 20% to about 45% by weight, more preferably from about 25% to about 40% by weight, and even more preferably from about 30% to about 40%) by weight of the total weight of the foamable composition.

C. Blowing Agent

Applicants have found that unexpected by highly desirable advantage can be achieved by the use of blowing agent, especially in combination with the other preferred aspects of the invention, comprising: (a) at least one chemical blowing agent, preferably water; and (h) at least one physical blowing agent, which preferably comprises, and in certain embodiments consisting essentially of at least one co-blowing agent selected from the group consisting of trans-1-chloro-3,3,3-trifluoropropenc. (HFCO-1233zd(E)); 1,1,1,3,3-pentafluoropropane (HFC-245fa); pentafluorobutane (365mfc), blends consisting essentially of at least about 80% of HFC-365mfc and 1,1,1,2,3,3,3-heptalluoroproparie (227ea), and combinations of any two or more of these.

In general, it is preferred that the blowing agent component is present in the reaction mixture in an amount of from about 0.5% to about 10% by weight based on the total weight of the reaction mixture (including the aromatic polyisocyanate component and the isocyanate-reactive component), and more preferably from about 1% to about 8% by weight, and even more preferably from about 1.3 to about 4% by weight.

In certain embodiments the blowing agent preferably comprises from about 55 mol % to about 98 mol % of chemical or reactive blowing agent, preferably consisting essentially of water, and from about 2 mol % to about 45 mol % by of a physical blowing agent. In preferred embodiments the physical blowing agent is selected from the group consisting of trans-1-chloro-3,3,3-trifluoropropene (HFCO-1233zd(E)), 1,1,1,3,3-pentafluoropropane (HFC-245fa); 1,1,3,3-pentafluorobutane (365mfc), ⁻blends consisting essentially of at least about 80% of HFC-365mfc and 1,1,1,2,3,3,3-heptafluoropropane. (227ea), and combinations of any two or more of these. In certain preferred embodiments, the chemical or reactive blowing agent, preferably water, is present in amounts of from about 55 to about 98 mol %, more preferably from about 70 to about 96 mol %, and even more preferably in certain embodiments in amounts for from about 80 mol % to about 95 mol % based on the total blowing agent components, and the physical blowing agent, preferably selected from the group as identified herein, is present in an amount of from about 2 mol % to about 50 mol %, more preferably from 2 to about 30 mol % and even more preferably in amounts of from about 3 mol % to about 20 mol % and even more preferably from about 3 mole % to about 10 mol % based on the total blowing agent components. In certain embodiments the chemical or reactive blowing agent, preferably water, is present in amounts of from about 85 mol % to about 95 mol % based on the total blowing agent components, and the physical blowing agent, preferably selected from the group as identified herein, is present in an amount of from about 5 mol % to about 15 mol % of the total blowing agent components.

D. Foam Modifying Agent

Applicants have found that certain of the physical properties of the foams formed according to the present invention can he unexpectedly maintained and/or enhanced by incorporation into the foamable composition one or more foam modifying agents. More specifically, applicants have found that in certain embodiments a level of density reduction is desired, and can be achieved according to the present invention by use of the blowing agent as described herein, but one or more foam properties are altered in a manner that is undesirable and/or unacceptable for certain applications. The properties that can be negatively impacted in such situations include (a) IFD at 25%; (b) IFD at 65%; (c) comfort factor; (4) compression set; and (e) resilience. Applicants have found that including certain select compounds or combinations of compounds (referred to herein for convenience but not by way of limitation) a “foam modifying agent” of the present invention in the present compositions can interact in an unexpected manner with the other components of the composition during the foaming process to result in an improvement in one or more, and preferably at least two of these properties.

Applicants have found that certain diol, trials and combinations of these are capable of acting as effective reinforcing agents according to the preferred aspects of the present invention. For foaming modifying agents comprising diols, the molecular weight of the diol is preferably from about 60 to about 250, more preferably about 85 to about 180. In particularly preferred embodiments dial is 1,4 butane diol. For foaming modifying agents comprising trials. The molecular weight of the triol is preferably from about 70 to about 5000, more preferably about 80 to about 265. In particularly preferred embodiments the triol has at least a secondary and more preferably a tertiary amine. In highly preferred embodiments, the triol is selected from glycerol, triisopropanolamine, and polyether triol having a molecular weight of from about 250 to 275, and preferably of about 265. In preferred embodiments, the amount of the foam modifying agent is present in the composition in an amount of from greater than about 0 to about 1%.

E) Catalysts

In preferred embodiments the catalysts comprise, and in certain embodiments consist in major proportion of, tertiary amines containing hydroxyl, primary or secondary amines. Preferably the amine catalyst such as TEDA and Dabco BL-11 are used, in addition low-emissive or even “non-emissive” catalyst as would typically he used in open-cell flexible foam, and even more preferably molded foam used for auto or other transportation seat foam. Examples of catalyst that may be useful according to the present invention are: Dabco NE300, NE600, NE310, Polycat 140, NE1070 and NE1190, Jeffcat ZF-10, triediylene diamine, and 2-(2 dimethylaminoethyloxy)-N,N-dimethylethanamine Dabco BL-11). The catalyst may also comprise in certain embodiments other catalytic materials that are known for use in minor amounts in flexible foam applications, including organo-metallic catalysts used for rigid foam would be included such as those based on tin, zinc, and bismuth.

### Foaming Methods

A) Molding Methods

It is contemplated that all known methods of forming open-cell, flexible polyurethane foam are adaptable for use in accordance with the present methods, and all such methods are within the broad scope of the present invention. In general, the molding aspects of the present invention include the step of providing a foamable, composition, preferably by mixing the polyol components and the isocyante components to form a reactive mixture, introducing the foamable composition into the mold, which is preferably a heated mold, and closing the mold. In preferred embodiments, the foamable composition sufficiently reactive to substantially fill the mold in a time period that is greater than about 2 seconds, and even more preferably in a time period greater than about 3 seconds and even more preferably in a time period that is greater than about 4 seconds. In certain embodiments, the time required to fill the mold is greater than one or more of preferred minimum mold-file time but less than about 15 seconds, more preferably less than about 10 seconds, and even more preferably less than about 8 seconds.

In preferred embodiments the mold is a heated mold heated to a temperature of at least about 120 C, and even more preferably from about 120 F to about 140 F.

In preferred embodiments, the amount of foamable composition introduced to the mold creates an overpack of from, about 0% to about 20%. As used herein, the term 0% overpack means introducing into the mold the theoretical amount of foamable composition that would be needed to fill the foam volume based on the free-rise density of the foamable composition. Other overpack values are based upon 0% overpack as this calculated.

Applicants have found that in certain preferred embodiments unexpected advantage can be achieved by conducting the molding step by using an overpack that is at least about 5%, more preferably at least about 10%, and even more preferably at least about 15%. More particularly, applicants have found that selection of relatively high overpack, including preferably an overpack value above about 10%, more preferably above about 12% and even more preferably above about 13%, can cause a substantial reduction in the compression set of the foam (whether the foam is MDI based, TIM based or a mixture of MIN and TIN) compared to a lower overpack value. Applicants have found that is unexpected advantage is desirable because in certain embodiments the use of the preferred co-blowing agent to achieve the desired free-rise density reduction can cause an unwanted, and in certain, cases, an unacceptable increase in compression set. This result is especially unexpected and advantageous in connection with Wet Compression Set (at 50 C. and 50% deflection and 95% Relative humidity (RH)), which in preferred embodiments of the present invention is less than 25% more preferably in certain embodiments of less than about 20%, preferably less than about 15%, preferably in certain embodiments less than 10%, and even more preferably in certain embodiments less than about 6%.

Articles

It is contemplated that any of the articles currently formed from flexible open-cell foam can be formed form the foams of the present invention. It is believed however that the molded foam formulations and the molding methods of the present invention are well suited to form automotive foams, including seat cushion foams, seat back foams, arm rest, dashboard, head rest, and head rest foams, as well as furniture foams, including particular office furniture.

It is believed however that the slab foam formulations and the slab forming methods of the pre-sent invention are well suited to form mattress foams, furniture foams, including sofas and large chairs and in airline seat foam.

### EXAMPLES

### Examples 1-3

In Examples 1-3 which follow, bench scale molded foams are prepared. The foamable compositions are all prepared using as the isocyanate component the MDI LUPRINATE M10 ((5 gal=31.8% NCO) and the indicated ingredients of the polyol master batch as listed in Table A below, unless specifically indicated herein.

TABLE A

| COMPONENT | MATERIAL | PROPERTIES |
|---|---|---|
| POLYOL A | DOW CP 6001 | Density at 21 C.-1.03 glee |
| | | Viscosity at 21 C.-1329 cp |
| | | MW functionality approx. = 3Hydroxyl |
| | | No. 26.5-28.5 KOH/g |
| POLYOL B | BASF Pluracol 1528 | Density at 25 C.-1.02 g/cc |
| | FF | Viscosity at 25 C.-5768 cp |
| | | MW approx. 3600 |
| | | 45% graft polymer content, 3 functionality |
| | | Hydroxyl No. 17-21 KOH/g |
| POLYOL C | BASF Pluracol 816 | Density at 25 C.-1.02 g/cc |
| | | Viscosity at 2.5 C.-900 cp |
| | | MW - 4800 g/mol 3 |
| | | functionality |
| | | Total Acid No. <= 0.010 |
| | | Hydroxyl No. 34-36 KOH/g |
| SURFACTANT A | Niax L3639 | |
| SURFACTANT B | Niax L3640 | |
| ISOCYANATE A | Lupranate, M10 | Low Functionality Polymeric - |
| | (MDI) | % NCO - 31.7 |
| | | Nominal Functionality - 2.2 |
| | | Viscosity (77 F.) - 60 cps |
| BLOWING | | |
| AGENTS | | |
| | WATER (Deionized) | |
| | HFCO-1233ZD(E) | |
| | HFC-245FA | |
| | HFC-365MFC | |
| | HFC-365MFC/HFC | |
| | 227EA (93/7 wt. ratio) | |
| FOAM MODIFIERS | | |
| | Dipropylene. Glycol | |
| CATALYST A | Niax EF 100 | |
| CATALYST B | Niax EF 600 | |
| FOAM ADDITIVE | Glycerol | |
| A | | |
| FoAm ADDITIVE | 1,4 Butane Diol | |
| B | | |

A polyol master batch is created by introducing the Polyols A-C and Surfactants A and B into a container. These materials are then mixed until uniform. Then the foam modifier (diproplylene glycol), the water, and the catalyst are added. Mixing is resumed for several minutes to produce the polyol master batch as indicated in Control Table 1 below.

TABLE 1
Control - Polyol Master Batch

| | | WT % IN THE | PARTS PER |
|---|---|---|---|
| | WEIGHT, | MASTER BATCH | HUNDRED |
| COMPONENT | grains | FORMULATION | POLYOL |
| POLYOL A | 1400 | 56.06 | 59.88 |
| POLYOL B | 48 | 1.92 | 2.05 |
| POLYOL C | 890 | 35.64 | 38.07 |
| SURFACTANT A | 8 | 0.32 | 0.34 |
| SURFACTANT B | 30 | 1.2 | 1.28 |
| FOAM MODIFIER | 27.5 | 1.1 | 1.18 |
| BLOWING AGENTS | | | |
| WATER | 76 | 3.04 | 3.25 |
| CATALYST A | 9 | 0.36 | 0.38 |
| CATALYST B | 9 | .36 | 0.38 |
| PHYSICAL PROPERTY | 0 | 0 | 0 |
| MODIFIER | | | |
| TOTAL | 2497.5 | 1.00.00 | 106.82 |

An open cell, flexible polyurethane foam was formed to be used as a control for Examples 1-3 using the master batch formulation as indicated above. To produce the 90 index foam, 236.6 grams of the Lupranate M10 (MDI) isocyanate and 488 grams of the polyol master batch (as modified according to each of the examples) are mixed together for about 8 seconds at 3000 RPM to simulate the results of a machine molding process. Then the combined ingredients which form a foamable, reactive composition are poured into a 14×14×4 inch aluminum mold preheated to and maintained during processing by a hot water jacket to about 130° F., with about 67 grams left in the can after the pour. Once the foam is poured into the mold the lid of the mold is immediately closed and sealed. The foam is maintained in the mold for 5 minutes; the foam is removed and immediately crushed to open many, and preferably substantially all, of any remaining closed cells. After crushing, the foam is allowed to cure at ambient conditions for about 24 hours. Indications of foam shrinkage are noted after this and then physical property measurements are made.

After being processed as indicated above to form a first foam, the procedure is repeated identically to form a second foam. The foams so produced are tested and found to have the average following physical properties,

| | |
|---|---|
| Density (PCF) | 3.22 |
| IFD 25% | 220 |
| IFD 65% | 598 |
| CV (65/25) | 2.7 |
| Tensile Strength, psi. | 12.3 |
| Elongation | 60.3 |
| 50% Compression Set | 23.0 |
| (at 95% RH and 50° C.) | |
| Resilience | 43.6 |
| CFD Hysteresis Loss | 24.9% |

### Example 1

Open cell, flexible polyurethane foams were formed using the same procedures and materials indicated above in connection with the control, except that for each sample the blowing agent was modified to include a co-blowing agent HFCO-1233zd(E) in an amount of about 2% by weight based on the total components in the foam, such that the total blowing agent had the following concentrations, with the total weight of the water in the formulation remaining unchanged:

| | | Wt % (based | Mol % (based |
|---|---|---|---|
| | Grains per 100 | on total | on total |
| BLOWING AGENT | parts foam | blowing agent) | blowing agent) |
| WATER | 2.14 | 51.7 | 94.1 |
| HFCO- | 2.0 | 48.3 | 5.9 |
| I 233ZD(E) | | | |

The amount of foamable composition use for pouring into the mold is adjusted to ensure filing of the mold and found to be about 658 grams (including the additional co-blowing agent), for a weight savings of approximately 9% in preparing the foam. The foams so produced are tested and found to have the following average physical properties and comparisons to the control:

| | CONTROL | EXAMPLE 1 | % CHANGE |
|---|---|---|---|
| DENSITY, PCF | 3.22 | 2.86 | −11.2 |
| 50% | 23.0 | 20.6 | −10.4 |
| COMPRESSION | | | |
| SET (at 95% RH | | | |
| and 50° C.) | | | |
| IFD 25% | 220 | 168 | −23.6 |
| IFD 65% | 598 | 472 | −21.1 |
| CV (25/65) | 2.7 | 2.8 | +4 |
| Tensile Strength, psi | 12.3 | 12.7 | +3 |
| Elongation | 60.3 | 63 | +4.5 |
| CFD Hysteresis Loss | 24.9 | 24.6 | −1.2 |

As can be seen from the above results, the addition of 1233zd(E) in approximately equal weight to the water blowing agent produces a highly desirable reduction in molded foam density (and associated weight savings). However, in this embodiment the foam exhibited an undesirably high reduction in MD 25% and 65%.

### Example 2

Open cell, flexible polyurethane foams were formed using the same procedures and materials indicated above in connection with Example 1, except that the additional polymer polyol was added to the master batch formulation in an amount sufficient to increase the total proportion of polymer polyol (polyol 131 to six (6) pphp while maintaining all other ratios of components substantially the same. The amount of foamable composition is adjusted to ensure filing of the mold and found to be about 658 grams (including the additional co-blowing agent), for a weight savings of approximately 9%. The foams so produced are tested and found to have the following average physical properties and comparisons to the control:

| | CONTROL | EXAMPLE 2 | % CHANGE |
|---|---|---|---|
| DENSITY, PCF | 3.22 | 2.88 | −10.56 |
| 50% | 23.0 | 22.9 | −0.4 |
| COMPRESSION | | | |
| SET (at 95% RH | | | |
| and 50° C.) | | | |
| IFD 25% | 220 | 180 | 48.2 |
| IFD 65% | 598 | 488 | −18.4 |
| CV (25/65) | 2.7 | 2.29 | −15.2 |
| Tensile Strength, psi | 12.3 | 12.1 | +1.6 |
| Elongation | 60.3 | 62.6 | +3.8 |
| CFD Hysteresis | 24.9 | 24.8 | 0 |
| Loss | | | |

As can be seen from the above result, the modification to increase the polymer polyol by about 4 pphp as proportion of the polyol, total (for a total of 6 pphp produces about the same density reduction and only a slight improvement in IFD25% (18.4 percent loss for Example 2 compared to a 23.6% loss for Example 1) and for IFD65% (15.2% loss for Example 2 compared to a 21.1% loss for Example 1).

### Example 3

Open cell, flexible polyurethane foams were formed using the same procedures and materials indicated above in connection with Example 1, except that the additional polymer polyol was added to the master batch formulation in an amount sufficient to increase the total of polymer polyol (polyol B) proportionally to ten (10) pphp while maintaining all other ratios of components substantially the same. The amount of foamable composition is adjusted to ensure filing of the mold and found to be about 658 grams (including the additional co-blowing agent), for a weight savings of approximately 9%. The foams so produced are tested and found to have the following average physical properties and comparisons to the control based on the average of the two samples tested:

| | CONTROL | EXAMPLE 3 | % CHANGE |
|---|---|---|---|
| DENSITY, PCF | 3.22 | 2.88 | −10.25 |
| 50% | 23 | 22.8 | |
| COMPRESSION | | | |
| SET (at 95% | | | |
| RH and 50° C.) | | | |
| IFD 25% | 220 | 215 | −2.2 |
| IFD 65% | 598 | 598 | 0 |
| CV (25/65) | 2.7 | 2.8 | +3.7 |
| Tensile Strength, psi | 12.3 | 12.4 | +0.8 |
| Elongation | 60.3 | 63.8 | +5.8 |
| CFD Hysteresis | 24.9 | 24.8 | 0 |
| Loss | | | |

As can be seen from the above results, modifying the formulation to achieve about 10 pphp of polymer polyol while maintain all other proportions produces about the same density reduction, about the same IFD 25% as the control, and about the same IFD65% as the control. This represents a dramatic and unexpected improvement in IFD25% (2.2 percent loss for Example 3 compared to a 23.6% loss for Example 1) and in IFD65% (0% Loss for Example 3 compared to a 21.1% loss for Example 1). This is an unexpected but highly advantageous result, indicating that it is possible to achieve density/weight improvements of approximately 8 15% for MDI molded foams while limiting the reduction in IFD25% and/or IFD65%, and preferably both, to about 5% or less, provided the amount of the polymer polyol in the formulation is proportionally greater than about 6 pphp, more preferably greater than about 8 pphp, and even more preferably at least about 10 pphp.

### Examples 4 and 5

Examples 2 and 3 are repeated, except that the co-blowing agent consisting of HCFO-1233zd(E) is replaced by co-blowing agent consisting of HFC-24fa in the same amount by weight. Similar successful results are obtained.

### Examples 6 and 7

Examples 2 and 3 are repeated, except that the co-blowing agent, consisting of HCFO-1233zd(E) is replaced by co-blowing agent consisting of a blend consisting essentially of about 80% by weight of HFC-365mfc and 2.0% by weight 1,1,1,2,3,3,3-heptafluoropropane (227ea) in the same amount by weight Similar successful results are obtained.

### Examples 8 and 9

Examples 2 and 3 are repeated, except that the co-blowing agent consisting of HCFO-1233zd(E) is replaced by co-blowing agent consisting of HFC-365mfc in the same amount by weight. Similar successful results are obtained.

### COMPARATIVE EXAMPLE

Example 1 is repeated, except that water replaces the 1233zd blowing agent on a one-to one molar basis. The foam produced has a reduced density similar to the density reduction achieved according to Example 1, but the IFD properties are considerably harder—which frequently undesirable, than the foam produced according to Example 1. In addition, the hysteresis loss and 50% Compression Set are much higher, which is also undesirable, than the foam produced according to Example 1.

Although the invention has been described in detail in the foregoing for the purposes including explanation and illustration, it is to be understood, that all of the recited detail is not necessarily limiting of the invention and that variations can be made therein by those skilled in the art without departing from the spirit and scope of the invention except as it may be limited by the claims presented herein below and as amended hereinafter.

1. A method of forming a flexible, open cell, MDI-based polyurethane molded foam comprising:
(a) providing a foamable, thermosetting composition capable of forming an open-cell, flexible MDI-based polyurethane foam, said composition comprising: (i) one or more isocyanate-reactive hydrogen containing compounds including at least one polymer polyol, wherein said polymer polyol is present in the formulation in an amount of greater than 6 pphp; and (ii) MDI-based isocyanate component; (iii) blowing agent, wherein the blowing agent comprises water and one or more co-blowing agents comprising one or more of trans-1-chloro-3,3,3-trifluoropropene (HFC0-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), wherein the amount of the co-blowing agent(s) is at least about 50% by weight of blowing agent composition; (iv) catalyst; (v) optionally surfactant; (vi) optionally foam modifier; and (vii) optionally other additives;
(b) molding said foamable composition to form a molded foam having a density of not greater than about 3 PCF and at least one of IFD25% and IFD65% that is not more than 5% less than the IFD25% or IFD65% of said formulation but containing 2 pphp or less of said polymer polyol.

2. The method of claim 1 wherein said co-blowing agent comprises HFCO-1233zd(E).

3. The method of claim 1 wherein said co-blowing agent consists essentially of HFC0-1233zd(E).

4. The method of claim 1 wherein said co-blowing agent consists of HFCO-1233zd(E).

5. An automotive seat cushion containing a foam formed according to the method of claim 1.

6. The method of claim 1 wherein said blowing agent comprises from about 70 to about 99 mole percent water and from about 1 to about 30 mole percent of said one or more co-blowing agents.

7. A molded MDI-based foam formed from a foamable composition comprising:
A) one or more polyisocyanates comprising at least about 50% by weight of di-isocyantes, polyisocyantes or combinations thereof;
B) one or more isocyanate-reactive hydrogen containing compounds including at least one polymer polyol, wherein said polymer polyol is present in the formulation in an amount of greater than 6 pphp;
C) blowing agent, wherein the blowing agent comprises water and one or more co-blowing agents comprising one or more of trans-1-chloro-3,3,3-trifluoropropene (HFC0-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), wherein the amount of the co-blowing agent(s) is at least about 50% by weight of blowing agent composition;
D) catalyst;
E) optionally but preferably surfactant;
F) optionally but preferably foam modifier; and
G) optionally other additives.

8. The foam of claim 7 wherein said co-blowing agent comprises HFCO-1233zd(E).

9. The foam of claim 7 wherein said co-blowing agent consists essentially of HFCO-1233zd(E).

10. The foam of claim 7 wherein said co-blowing agent consists of HFCO-1233zd(E).

11. The foam of claim 4 wherein said blowing agent comprises from about 70 to about 99 mole percent water and from about 1 to about 30 mole percent of said physical co-blowing agent.

12. A foamable composition comprising:
A) one or more polyisocyanates comprising at least about 50% by weight of at least about 50% by weight of di-isocyantes, polyisocyantes or combinations thereof;
B) one or more isocyanate-reactive hydrogen containing compounds including at least one polymer polyol, wherein said polymer polyol is present in the formulation in an amount of greater than 6 pphp;
C) blowing agent, wherein the blowing agent comprises water and one or more co-blowing agents comprising one or more of trans-1-chloro-3,3,3-trifluoropropene (HFCO-1233zd(E)), 1,1,1,3,3-pentafluoropropane (HFC-245fa); 1,1,1,3,3-pentafluorobutane (365mfc), blends consisting essentially of at least about 80% of HFC-365mfc and 1,1,1,2,3,3,3-heptafluoropropane (227ea), wherein the amount of the co-blowing agent(s) is at least in preferred embodiments about 50% by weight of blowing agent composition;
D) catalyst;
E) optionally but preferably surfactant;
F) optionally but preferably foam modifier; and
G) optionally other additives.

13. The foamable composition of claim 12 wherein said co-blowing agent comprises HFC0-1233zd(E).

14. The foamable composition of of claim 12 wherein said co-blowing agent consists essentially of HFC0-1233zd(E).

15. The foamable composition of claim 12 wherein said co-blowing agent consists of HFC0-1233zd(E).

16. The foamable composition of claim 12 wherein said blowing agent comprises from about 70 to about 99 mole percent water and from about 1 to about 30 mole percent of said physical co-blowing agent.

17. The method of claim 1 wherein said foam has a density of not greater than about 2.5 pounds per cubic foot, said density of said foam being at least about 8 relative percent less than the density of said foam produced using the same method but without said co-blowing agent, and wherein the IFD at 25% as measured by ASTM D3574 Test B1 of the foam is not increased by more than 10 percent compared to the foam produced using the same method but without said co-blowing agent.

18. The method of claim 1 wherein said foam has a density of not greater than about 2.5 pounds per cubic foot, said density of said foam being at least about 8 relative percent less than the density of said foam produced using the same method but without said co-blowing agent, and wherein the CV of the foam is from about 2.2 to about 2.8.

19. The method of claim 1 wherein said foam has a density of not greater than about 2.5 pounds per cubic foot, said density of said foam being at least about 8 relative percent less than the density of said foam produced using the same method but without said co-blowing agent, and wherein the comfort factor is not degraded by more than about 10 relative percent compared to the foam produced using the same method but without said co-blowing agent.

20. The method of claim 1 wherein said foam has a density of not greater than about 2.5 pounds per cubic foot, said density of said foam being at least about 8 relative percent less than the density of said foam produced using the same method but without said co-blowing agent, and wherein the CFD hysteresis loss of said foam is not substantially increased relative to the foam produced using the same method but without said co-blowing agent.
